(19) United States
(12) Patent Application Publication
(10) Pub. No.: US 2026/0009315 A1
(43) Pub. Date: Jan. 8, 2026

(54) METHODS FOR HYDRAULIC FRACTURING AND WELLBORE STARTUP

(71) Applicant: SCHLUMBERGER TECHNOLOGY CORPORATION, Sugar Land, TX (US)

(72) Inventors: Denis Viktorovich BANNIKOV, Koltsovo (RU); Ivan Vladimirovich VELIKANOV, Novosibirsk (RU); Vadim Ismailovich ISAEV, Novosibirsk (RU); Leonid Georgievich SEMIN, Novosibirsk (RU); Maxim Grigorievich IVANOV, Novosibirsk (RU)

(21) Appl. No.: 18/998,591

(22) PCT Filed: Jul. 25, 2023
(86) PCT No.: PCT/US2023/028525

§ 371 Date: Jan. 27, 2025

(30) Foreign Application Priority Data
Jul. 25, 2022 (RU) 2022120415

(51) Int. Cl. E21B 43/26

(52) U.S. Cl. CPC E21B 43/26; E21B 2200/20

(57) ABSTRACT

Properties of reservoir rock, hydraulic fracturing materials and a wellbore to be stimulated are determined. One or more preliminary designs for hydraulic fracturing and well production is selected. The data and designs are entered into one or more computer models for calculating well productivity after the hydraulic fracturing treatment. A treatment and well startup design is selected that will provide maximum well productivity, and work proceeds accordingly.

### CROSS REFERENCE

This application claims the benefit of Russian Non-Provisional Application No. 2022120415, entitled “METHODS FOR HYDRAULIC FRACTURING AND WELLBORE STARTUP,” filed Jul. 25, 2022, the disclosure of which is hereby incorporated herein by reference.

### BACKGROUND

The statements in this section merely provide background information related to the present disclosure and may not constitute prior art.

For decades, the oil and gas industry has performed hydraulic fracturing to enhance or prolong well productivity. Without fracturing, producing from most hydrocarbon reservoirs being developed today would not be technically or economically feasible.

During a fracturing treatment, specialized equipment pumps fluid into a well faster than can be absorbed by the formation. This causes pressure on the formation to rise until the rock fractures or breaks down. Continued pumping causes the fracture to propagate away from the wellbore, increasing the formation surface area from which hydrocarbons can flow into the wellbore. This helps the well achieve a higher production rate than would otherwise be possible. As a result, the volume of produced hydrocarbons increases dramatically, and operators recover their development investments more quickly.

Fracturing operations employ two principal substances-proppants and fracturing fluid. Proppants are particles that hold the fractures open, preserving the newly formed pathways. Fracturing fluids may be aqueous or nonaqueous and must be sufficiently viscous to create and propagate a fracture and also transport the proppant down the wellbore and into the fracture. Once the treatment ends, the fracturing fluid viscosity must decrease enough to promote its rapid and efficient evacuation from the well.

Traditional fracturing treatments consist of two fluids. The first fluid, or pad, does not contain proppant and is pumped through casing perforations at a rate and pressure sufficient to break down the formation and create a fracture. The second fluid, or proppant slurry, transports proppant through the perforations into the open fracture. When pumping ceases, the fractures close, holding the proppant pack in place, and the fracturing fluid flows back into the wellbore to make way for hydrocarbon production. Ideally, the proppant pack should be free of fluid residue that can impair conductivity and hydrocarbon production.

For more than 60 years, chemists and engineers have sought to develop fracturing fluids, proppants and placement techniques that help produce ideal propped fractures and maximize well productivity. As a result, the chemical and physical nature of the fluids has evolved significantly. The industry has introduced essentially residue-free fracturing fluids. Heterogeneous proppant packs have further maximized proppant pack conductivity, exemplified by the HIWAY® flow-channel hydraulic fracturing technique, available from Schlumberger.

During conventional fracturing treatments, proppant is present throughout the entire proppant-slurry volume. During HIWAY® treatments, the proppant-slurry stage comprises alternating fluid pulses—with and without proppant. The resulting proppant “slugs” are placed in the fracture and form proppant pillars. Such columnar proppant packs pose little resistance to fluid flow, at least initially. However, during well production, reservoir fluids flowing through the proppant pack toward the wellbore may exert stresses that may result in proppant flowback (i.e., flow of proppant from the fracture into the wellbore), degradation of the proppant pillars, or both. These processes may reduce fracture width and ultimately reduce well productivity.

More information concerning the HIWAY® technique may be found in the following publication. d'Huteau E et al.: “Open-Channel Fracturing—A Fast Track to Production,” Oilfield Review Autumn 2011:23, no. 3, 4-17.

### SUMMARY

The present disclosure proposes hydraulic fracturing methods and well startup procedures for maximizing wellbore production while accounting for fracture conductivity degradation during the production period.

In an aspect, embodiments relate to methods for hydraulic fracturing and wellbore startup. The methods comprise determining the properties of a reservoir, hydraulic fracturing materials and a wellbore to be stimulated. Then, one or more preliminary designs for hydraulic-fracturing treatments and the initiation of well production are selected. The data from these initial stages are entered into one or more computer models that calculate well productivity after the hydraulic fracturing treatment. Treatment and well-startup designs are selected. A hydraulic fracturing treatment is performed according to the selected design. Then, well startup and production is initiated according to the selected design.

### BRIEF DESCRIPTION OF THE DRAWINGS

FIG. 1 presents the proposed modeling workflow of the present application.

FIG. 2 depicts the geometry of a fracture that is considered by hydraulic fracturing models.

FIG. 3 depicts the stresses that proppant may be subjected to in fracture.

FIG. 4 depicts a propped fracture without a channel.

FIG. 5 depicts a propped fracture with a channel.

FIG. 6 illustrates the geometry of a heterogeneous proppant pack in a simulation of proppant pack deformation.

FIG. 7 is a graph that illustrates the aperture width of a fracture under different effective stresses.

FIG. 8 is a graph that illustrates the effect of reservoir pressure on the permeability reduction factor for a fracture arising from rock compaction.

FIG. 9 is a graph showing the effective wellbore radius at a dimensionless fracture conductivity (CFD) of 10.

FIG. 10 is a graph showing a comparison of calculated and history-matched permeability reduction of a 20/40-mesh sand pack versus closure pressure.

FIG. 11 is a diagram showing a nonuniform conductivity distribution in a hydraulic fracture.

FIG. 12 is a diagram showing constant velocity contours in a hydraulic fracture, and an area with a high risk of proppant flowback.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions are made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the disclosure and this detailed description, each numerical value should be read once as modified by the term “about” (unless already expressly so modified), and then read again as not so modified unless otherwise indicated in context. The term about should be understood as any amount or range within 10% of the recited amount or range (for example, a range from about 1 to about 10 encompasses a range from 0.9 to 11). Also, in the summary and this detailed description, it should be understood that a concentration range listed or described as being useful, suitable, or the like, is intended that any concentration within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, even if specific data points within the range, or even no data points within the range, are explicitly identified or refer to a few specific, it is to be understood that inventors appreciate and understand that any data points within the range are to be considered to have been specified, and that inventors possessed knowledge of the entire range and the points within the range.

As used herein, “embodiments” refers to non-limiting examples disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Moreover, the schematic illustrations and descriptions provided herein are understood to be examples, and components and operations may be combined or divided, and added or removed, as well as re-ordered in whole or part, unless stated explicitly to the contrary herein. Certain operations illustrated may be implemented by a computer executing a computer program product on a computer readable medium, where the computer program comprises instructions causing the computer to execute one or more of the operations, or to issue commands to other devices to execute one or more of the operations.

As discussed earlier, fracture conductivity strongly affects wellbore production after hydraulic fracturing treatment. Previously there have been no tools for designing hydraulic fracturing treatments and wellbore startups that can maximize wellbore production while accounting for fracture conductivity degradation during the production period. Applicant proposes such tools in the present application.

Published information concerning studies and methods in the industry concerning proppant pack permeability, fracture modeling and proppant flowback may be found in the following references.

Fredd C N et al.: “Experimental Study of Fracture Conductivity for Water-Fracturing and Conventional Fracturing Applications,” paper SPE-74138-PA (2001). This paper describes the experimental data for fracture conductivity in the absence of proppants.

Darin S R and Huitt J L: “Effect of a Partial Monolayer of Propping Agent on Fracture Flow Capacity,” paper SPE-1291-G (1960). This paper shows that a modified form of the Kozeny-Carman relation could be used to describe the flow in the partial monolayer propped fracture.

Altman R et al.: “Understanding the Impact of Channel Fracturing in the Eagle Ford Shale through Reservoir Stimulation,” paper SPE-153728-MS (2012). This paper proposes a consistent history matching methodology. This workflow is applied across multiple wells.

Samuelson M et al.: “Field Development Study: Channel Fracturing Achieves Both Operational and Productivity Goals in the Barnett Shale,” paper SPE-155684-MS (2012). This paper shows the simulation results for more than 50treatments indicating that the channel fracturing technique increased operational efficiency at equivalent well production in the study area of the Barnett shale.

Gillard M et al.: “A New Approach to Generating Fracture Conductivity,” paper SPE-135034-MS (2010). This paper describes a novel hydraulic fracturing technique that enables a step-change approach towards increasing fracture conductivity. The technique is based on the creation of a network of open channels inside the fracture.

Settgast R R et al.: “Optimized Cluster Design in Hydraulic Fracture Stimulation,” paper URTEC-2172691-MS, presented at the SPE/AAPG/SEG Unconventional Resources Technology Conference, San Antonio, TX, USA, July 2015. This work presents a method for the evaluation of the effects that cluster spacing and frictional properties of perforation clusters have on the propagation of hydraulic fractures during a stimulation stage.

Akuanyionwu O et al.: “Examination of Hydraulic Fracture Production Modeling Techniques,” paper SPE-157045-MS (2012). This paper considers different production modeling techniques to a range of fracture treatment scenarios and compared several real case studies and examples from the North Sea area.

Stegent N et al.: “Hydraulic Fracture Stimulation Design Considerations and Production Analysis,” paper SPE-139981-MS (2011). This paper describes process that engineers are encouraged to follow when deciding what type of completion should be used to fracture stimulate a shale reservoir (water frac, hybrid, or conventional).

Mirzaei M and Cipolla C L: “A Workflow for Modeling and Simulation of Hydraulic Fractures in Unconventional Gas Reservoirs,” paper SPE-153022-MS (2012). This paper describes a reservoir modeling and simulation technique that has been developed for complex fracture networks and combines discrete fracture network (DFN) modeling and unstructured fracture (UF) modeling to simulate well performance and improve stimulation design. Workflows are presented for modeling, simulation, and ultimate recovery forecast of a well with hydraulic fractures in an unconventional shale gas reservoir.

Jochen V et al.: Production Data Analysis: Unraveling Rock Properties and Completion Parameters,” paper SPE-147535-MS (2011). This paper describes the production prediction for shale gas reservoirs and provides a vision of possibilities for better interpretation (i.e., production models must go hand-in-hand with hydraulic fracture models to determine the crucial parameters that drive production; thus fully optimizing well and field production. Analytical, statistical and numerical approaches, as well as complex HF modeling in an unconventional fracture model (UFM), are presented.

Karantinos E et al.: “Choke-Management Strategies for Hydraulically Fractured Wells and Frac-Pack Completions in Vertical Wells,” paper SPE-173973-PA (2018). This paper contains a comparison of choke management strategies for a wide range of formation and fracture properties including fluid properties, matrix permeability, fracture conductivity and fracture length.

Willberg D M et al.: “Control System and Method of Flowback Operations for Shale Reservoirs,” patent WO 2016118802 A1. This invention comprises a flowback system and method employ a flowback model that characterizes fluid properties and rock mechanical properties of the reservoir during flowback in conjunction with measurement and analysis of chemistry and solids production with respect to the flowback.

Potapenko D I et al.: “Securing Long-Term Well Productivity of Horizontal Wells Through Optimization of Postfracturing Operations,” paper SPE-187104-MS (2017). This paper proposes a secure operational envelope providing a set of operating parameters that ensure preservation of the connection between the hydraulic fractures and wellbore.

Tompkins D et al.: “Managed Pressure Flowback in Unconventional Reservoirs: A Permian Basin Case Study,” paper URTEC-2461207-MS (2016). This paper focuses on the specific type of damage that can be created by aggressive flowback practices and how this damage can be mitigated by effectively monitoring and controlling initial rates and pressures.

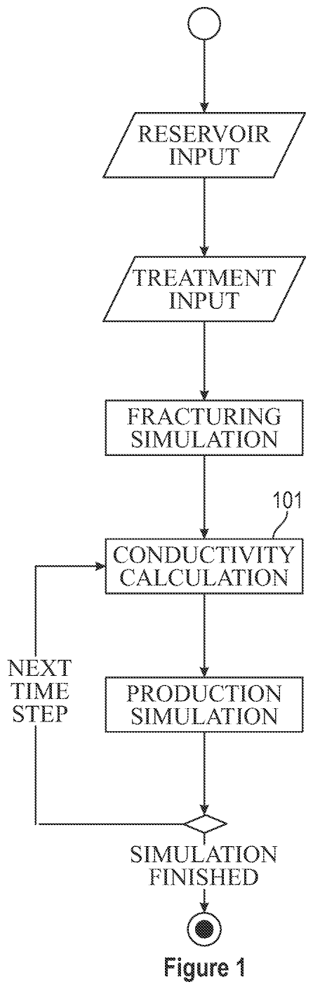

Applicant proposes methods for the design of hydraulic fracturing treatments and wellbore startups based on models simulating hydraulic fracturing, fracture conductivity degradation, and wellbore production. As discussed earlier, conductivity degradation may be caused by the closure of fracture faces during production owing to a fluid pressure decrease, rock stress, and proppant flowback arising from the pressure drop between reservoir and wellbore. A modeling workflow is presented in FIG. 1. Reservoir properties and a job design are entered into a fracturing simulator, providing the hydraulic fracture geometry after the treatment and the proppant distribution inside the fracture. The wellbore production simulation is performed using time steps. Fracture conductivity is calculated at each step, accounting for its degradation caused by pressure drawdown and proppant flowback.

In an aspect, embodiments relate to methods for hydraulic fracturing and wellbore startup. The methods comprise determining the properties of a reservoir, hydraulic fracturing materials and a wellbore to be stimulated. Then, one or more preliminary designs for hydraulic-fracturing treatments and the initiation of well production are selected. The data from these initial stages are entered into one or more computer models that calculate well productivity after the hydraulic fracturing treatment. Treatment and well-startup designs are selected. A hydraulic fracturing treatment is performed according to the selected design. Then, well startup and production is initiated according to the selected design.

The one or more computer models may comprise those for hydraulic fracturing, fracture conductivity and well production. The fracture conductivity model may account for a pressure-drop effect between the reservoir and the wellbore as the fracture conductivity decreases. The fracture conductivity model may account for proppant flowback during well production. The well production model may account for heterogeneous distribution of fracture conductivity evolving with time.

The selection of the one or more preliminary designs may comprise selection of concentrations and volumes of hydraulic fracturing materials and pumping rate. The selection of the one or more preliminary designs may comprise selection of a maximal pressure drop between the reservoir and the wellbore during wellbore startup and production. The selection of the one or more preliminary designs may comprise pulsing the injection of the hydraulic fracturing materials.

The treatment design may be selected to maximize well productivity.

The maximal pressure drop between the reservoir and the wellbore may be selected to maximize well productivity.

The hydraulic fracturing materials may comprise fluids, proppant and additives. The additives may comprise fibers, fluid-loss additives, diverting agents, breakers, corrosion inhibitors, friction reducers, scale inhibitors, surfactants, water soluble polymers, oil-soluble polymers, crosslinkers, biocides, pH adjusting agents or buffers, or combinations thereof.

Fracturing Simulation

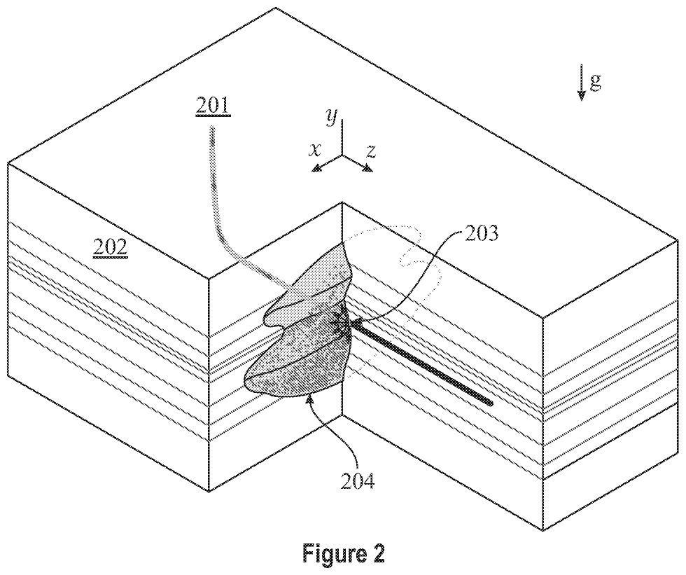

The fracture geometry presented in FIG. 2 may be simulated in any hydraulic fracturing model; for example, the Kristianovich-Geertsma-de Klerk (KGD), Perkins-Kern-Nordgren (PKN), radial, pseudo 3D, planar 3D, full 3D and UFM approaches. The input and output data of the models are listed below. Here, 201 is the wellbore, 202 are reservoir layers, 203 is the slurry inflow zone and 204 is the fracture propagation front (tip).

### Input Data

1. Reservoir:
   a. Spatial distribution of rock elastic properties: Young's modulus E and Poisson's ratio v.
   b. Spatial distribution of the minimal principal horizontal stress o in the rock.
2. Treatment:
   a. Materials: fluids, proppants, fibers, additives.
   b. Pumping schedule: material concentrations at the wellhead, injection rate and injected volume.

### Output Data

1. Fracture aperture distribution w_{f}(x, y).
2. Propped width distribution wₚ(x, y).
3. Volume fractions of proppants.

### Conductivity Calculation

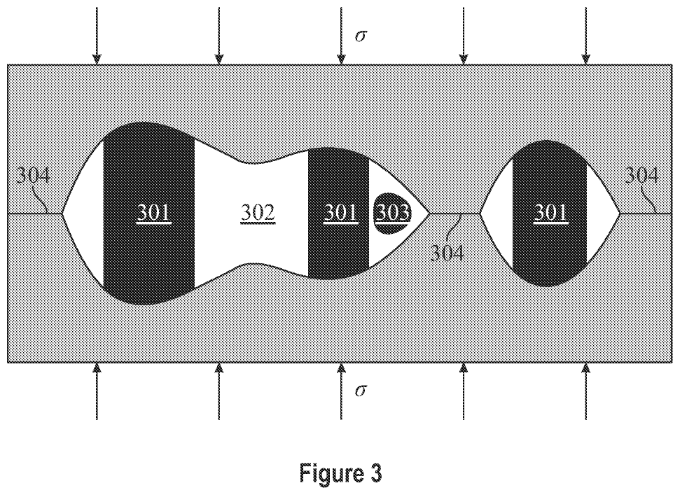

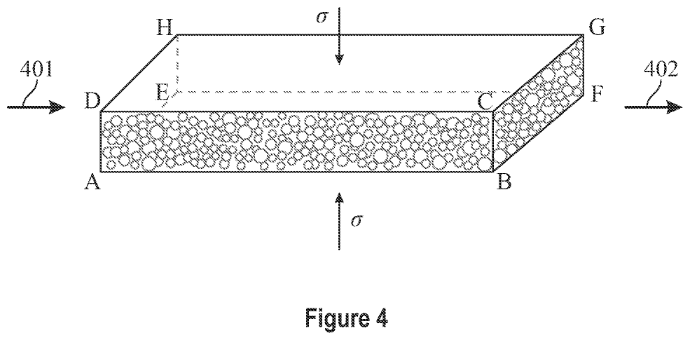

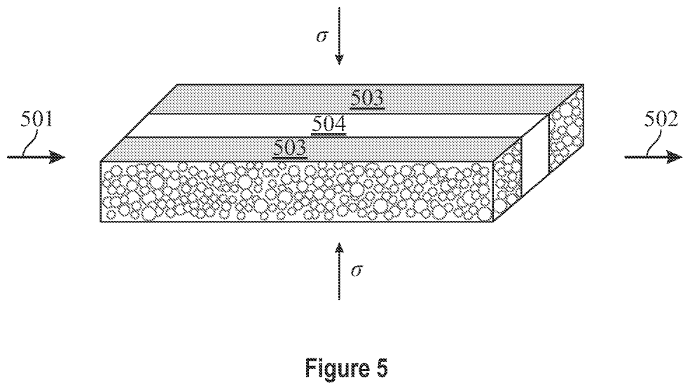

The spatial distribution of hydraulic fracture conductivity depends on the proppant distribution calculated by the fracturing simulator, minimum principal stress and fluid pressure. As presented in FIG. 3, the proppant pack can be subjected to stress 301 and can be unstressed 303. Fracture faces can form an open channel between proppant pillars 302 and can touch each other forming pinch points 304. The effective conductivity of an open channel is w_{f}³/12. The conductivity of a closed channel can be estimated using the data from paper SPE-74138-PA (cited above). The input data for the conductivity model comprises the input data for the fracturing simulator supplemented with the following.
a. Fluid pressure at perforations (can be taken from the production simulator at the previous simulation stage),
b. Experimental data for proppant pack permeability at different stresses measured in laboratory experiments,
c. Data describing the deformation of the proppant pack under stress,
d. Data for breakthrough superficial velocity v_{bt} measured at different stresses in flowback experiments, shown schematically in FIGS. 4 and 5 when the proppant pack is eroded by fluid flux. The superficial velocity vₛ=Q/A, where Q is volumetric flow rate through cross-sectional area A (e.g., A is the area of the rectangle AEHD in FIG. 4).

FIG. 4 shows the direction of inflow 401 and outflow 402. FIG. 5 shows the direction of inflow 501, outflow 502, the location of proppant 503, and an unpropped channel 504.

The conductivity model calculates the deformation of fracture faces and the proppant pack under applied closure stress via the solution of a coupled-contact problem for rock and proppant deformation. It can be solved via the displacement discontinuity method. The closure stress is affected by the minimal horizontal principal stress and fluid pressure that evolves during the production period. These calculations predict fracture conductivity degradation caused by pressure drawdown during production.

The conductivity model calculates the distributions of fluid pressure and fluxes in the fracture for a given pressure drawdown and estimates inflow from the reservoir to evaluate whether the superficial velocity in proppant pack exceeds v_{bt}. When it does, the corresponding portions of proppant are removed due to flowback. The fluxes can be calculated via a finite-volume method. These calculations represent the effect of proppant flowback on conductivity.

Finally, the conductivity model provides the spatial distribution of fracture conductivity C_{f}=k_{f}w_{f} to be used for the next production simulation time step.

### Production Simulation

Wellbore production after a hydraulic fracturing treatment depends on the distribution of fracture conductivity affected by fluid pressure and fluxes of produced fluid. This is coupled problem that may be solved by multiple workflows.

In one embodiment with a “coupled” workflow, the calculation of fracture conductivity and production forecast at each time step is performed iteratively until convergence to obtain the best accuracy of the simulation. However, it requires significant computational time.

In another embodiment with a “partially coupled” workflow, the calculation of fracture conductivity and production forecast is performed using the pressure and fluxes distribution obtained at the end of the previous time step. This workflow is faster than the “coupled” one, but it is less stable and accurate.

In yet another embodiment with an “uncoupled” workflow, a table of effective pack permeability is calculated before the production simulation. This table represents the permeability at different fluid pressures. It is used further at each production simulation time step for rapid recalculation of conductivity distribution without using a comprehensive fracture closure model. This workflow is supported by existing commercial production simulators such as ECLIPSE and INTERSECT.

For better accuracy, multiple tables of effective pack permeability could be calculated for local areas of the fracture with different parameters of heterogeneous proppant distribution: channel dimensions, proppant type, etc. For example, they could be prepared for each cell of a grid covering the fracture.

For a rapid production forecast, an effective fracture conductivity constant can be introduced for a given heterogeneous proppant distribution. It is selected to have the same productivity index as that for nonuniform conductivity.

### Calculation of Pack Permeability Tables

To build the table, the following workflow is proposed.
1. Select ascending closure stresses σ₁, . . . , σ_{N}.
2. For each stress of, calculate the fracture face deformation and the distribution of local pack permeability. Simulate the flow through this pack and calculate the effective constant permeability providing the same flow rate under a given pressure drop.
3 Enter the effective permeabilities in a table (Table 1) and calculate the compaction induced permeability multipliers as the ratio of permeability to the reference value.

TABLE 1
Example of compaction induced permeability reduction table

| Stress | Permeability | Compaction multiplier |
|---|---|---|
| σ₁ | k(σ₁) | 1 (reference value) |
| σ₂ | k(σ₂) | k(σ₂)/k(σ₁) |
| . . . | . . . | . . . |
| σ_{N} | k(σ_{N}) | k(σ_{N})/k(σ₁) |

### EXAMPLES

For the following examples, 20/40-mesh sand was considered as the proppant. Proppant pack permeabilities and compaction multipliers are given as a function of closure stress. The Young's modulus of the proppant pack Eₚ was 335 MPa, Poisson's ratio v=0.25. The dependence of sand pack permeability versus stress is presented in Table 2.

TABLE 2
Permeability of 20/40-mesh sand proppant packs
versus stress from experimental data.

| Stress, | Permeability, | Compaction |
|---|---|---|
| psi | D | multiplier |
| 1000 | 249 | 1.0 |
| 2000 | 232 | 0.93 |
| 4000 | 159 | 0.64 |
| 6000 | 82 | 0.33 |
| 8000 | 38 | 0.15 |

### Example 1—Aperture of Heterogeneous Proppant Placement

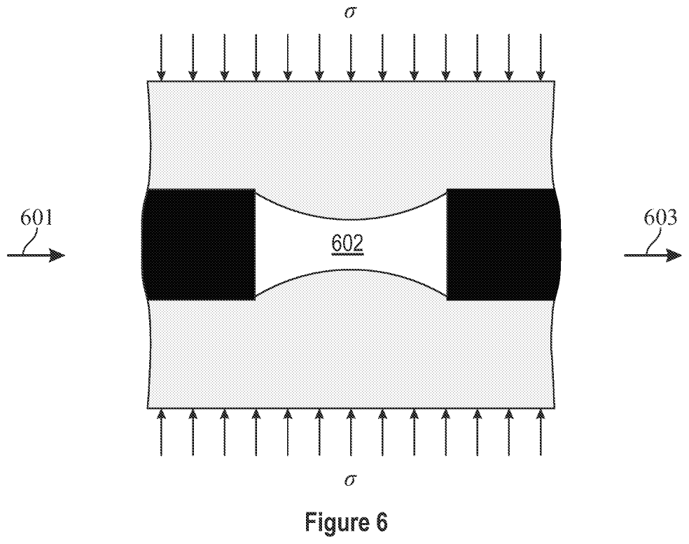

The compaction multipliers for the permeability of a channel between two pillars were calculated. The simulation domain is presented in FIG. 6 with inflow 601 and outflow 603. A square domain 2 m ×2 m was filled with 20/40-mesh sand of 0.01 m in height. In the center of the domain, a narrow channel 602 of 0.7 m width was created by removing proppant.

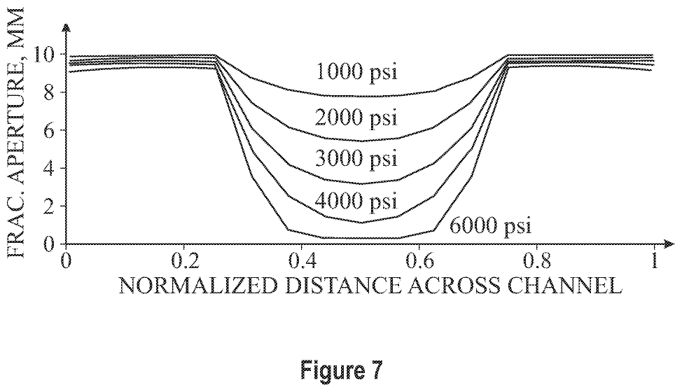

FIG. 7 presents the fracture face deformation results. The higher the effective stresses acting on rock, the higher the pillar deformation and the narrower the channel. At effective stresses greater than 5000 psi, a pinch-point in the center of the channel appeared and the permeability of the fracture tended towards the reservoir permeability.

The compaction multipliers are shown in Table 3. There was a noticeable difference between compaction multipliers for a proppant pack and for a channel. The channel closed at stress 5000 psi and the permeability decreased. Such behavior may be typical for channels and for heterogeneous proppant placement. It should be carefully accounted for in modern production simulators and avoided for better production.

TABLE 3
Compaction multipliers for a channel
between pillars at different stresses

| Stress, | Average | Conductivity, | Permeability, | Compaction |
|---|---|---|---|---|
| psi | aperture, mm | mD-m | mD | multiplier |
| 0 | 10.0 | | — | — |
| 1000 | 8.79 | 10,308 | 3,314 | 1.0 |
| 2000 | 7.58 | 6,412 | 2,830 | 0.85 |
| 4000 | 5.63 | 1,379 | 2,079 | 0.63 |
| 5000 | 5.18 | 0.005 | 1 | 0.0003 |

In “traditional” reservoir simulators the compaction multiplier for a channel is set to 0 for any stress >0. Additional information may be found in the following publication. Pettersen Ø: “Compaction, Permeability, and Fluid Flow in Brent-Type Reservoirs Under Depletion and Pressure Blowdown,” The Open Petroleum Engineering Journal 3(1) December 2011. Table 3 reveals that a channel produces higher permeability up to 4000 psi closure pressure, and then proppant pack permeability decreases at higher pressures.

### Example 2—History Matching From a Field Case (Production Analysis)

The following example is based on the results of production analysis for Bakken/Three Forks Formation (North Dakota, USA). A comprehensive reservoir simulation model was constructed to study the impact of reservoir and hydraulic fracturing parameters of the HiWAY® technique. The model was history matched with the following sensitivity study. One of the history matching parameters of the model was pore-pressure dependent fracture permeability (compaction table), which represents permeability reduction in a matrix and fractures as a function of production time.

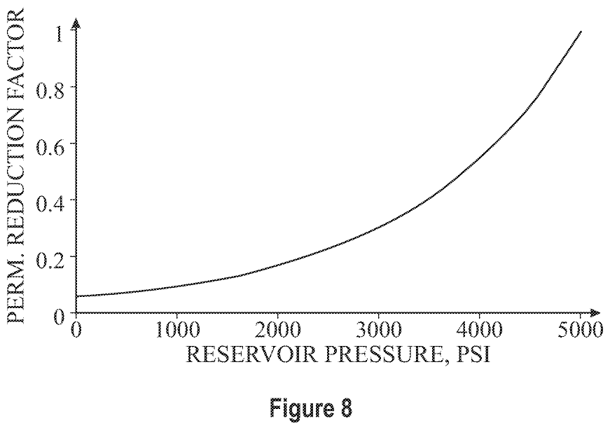

FIG. 8 shows the rock compaction curve used as an initial input into the model to account for fracture degradation with time. ECLIPSE software (available from The Eclipse Foundation) was employed. The example indicates that, at the beginning of production, when the pressure inside the fractures was close to the original reservoir pressure (≈5100 psi), the transmissibility multiplier Tr was 1.0, meaning that there was no fracture degradation. If the pressure inside the fracture were to decrease to 15 psi, the Tr would be 0.05. In this case, the fracture permeability (k_{f}) would decrease to 5% of the initial value during production.

The history matching workflow was applied to the well. The final history-matched fracture compaction curve for the HiWAY® technique indicated that there was no reduction in fracture permeability until the pressure inside the fracture fell below 4000 psi. After that, there was a sudden change in production, indicating collapse of the channels inside the fracture.

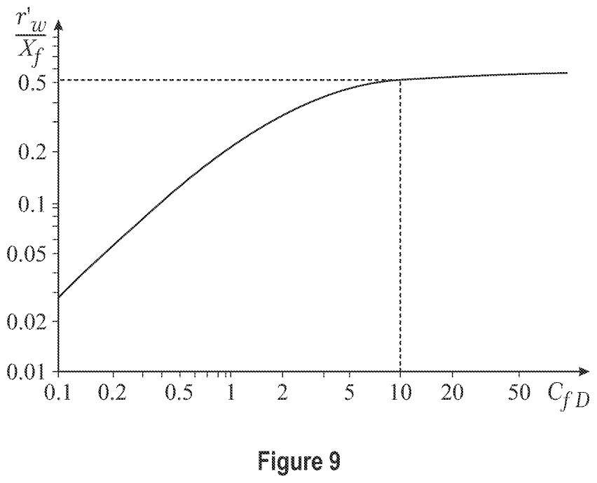

Considering the balance of reservoir and fracture production characteristics by means of dimensionless fracture conductivity and the Prats concept of effective wellbore radius, the data have been normalized from Table 3. The principal idea was to calculate the value of fracture permeability that corresponds to maximum production based on the correlation proposed by Prats: Prats M: “Effect of Vertical Fractures on Reservoir Behavior-Incompressible Fluid Case,” paper SPE 1575-G (1961). This is achieved at C_{fD}=10, where

$${C}_{fD} = \frac{{k}_{f} {w}_{f}}{{kx}_{f}} ,$$

where fracture half-length x_{f}=30.5 m, formation permeability k=0.16 mD, and average fracture width w_{f}=0.01 m (FIG. 9).

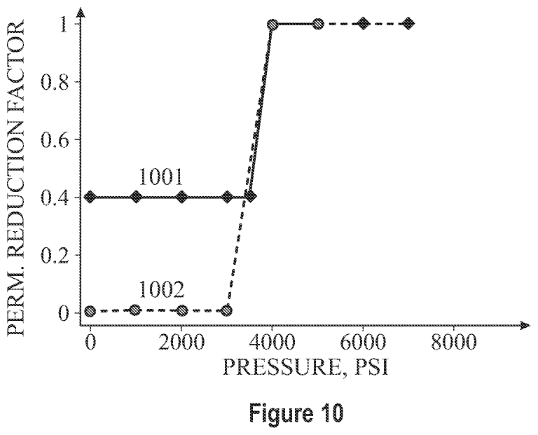

Based on these data and the C_{fD} equation above, a cutoff of 48 D for fracture permeability was obtained. Thus, the compaction results of Table 3 may be recalculated, considering that there is no compaction above 48 D. This is reasonable because there will be no effect on production at higher permeabilities. The results of the independent history matched compaction curve and the workflow described in this application are presented in FIG. 10 for 20/40 sand, where the history matched curve is 1001, and the calculated one is 1002. One can see that the permeability drops matched between 4000 and 3000 psi. The latter mismatch may be explained by the fact that the reservoir pressure did not fall below 3000 psi, and therefore the compaction curve was not history matched at lower pressures.

### Example 3—Effective Constant Conductivity for Non-uniform Conductivity Distribution, Proppant Flowback Area

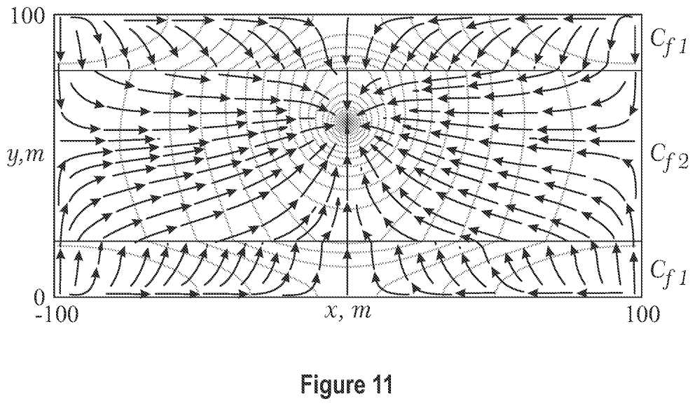

Consider a hydraulic fracture of width w_{f}=3 mm with the nonuniform conductivity distribution presented in FIG. 11. Fracture conductivity is C_{f2}=3 e⁻¹² m³ in the horizontal layer 20 m<y<80 m and it is C_{f1}=3 e⁻¹³ m³ otherwise. For a formation linear flow production regime (SPE-7490-PA), the flow in the fracture is described by the following equation.

$$- \frac{\partial }{\partial x} ( \frac{{C}_{f}}{μ} \frac{\partial p}{\partial x} ) - \frac{\partial }{\partial y} ( \frac{{C}_{f}}{μ} \frac{\partial p}{\partial y} ) = C ( {p}_{r} - p ) , C = 2 \sqrt{\frac{k ϕ {c}_{t}}{πμ t}} ,$$

where k=1 e⁻¹³ m² and ϕ=0.2 are reservoir permeability and porosity, respectively, μ=1 e⁻³ Pa·s is reservoir fluid viscosity, cₜ=1 e⁻⁸ 1/Pa is total compressibility, t=2.6 e⁺⁶ s (30 days) is production time. The pressure at perforations is set to constant p_{w}. The inflow into the wellbore Q (production rate) is the integral of the normal components of fluxes.

$${q}_{x} = \frac{{C}_{f}}{μ} \frac{\partial p}{\partial x} , {q}_{x} = \frac{{C}_{f}}{μ} \frac{\partial p}{\partial x}$$

over the boundary of cells with perforations. The perforation in this case was located at x=0 m, y=61 m. FIG. 11 presents the streamlines and isobars calculated using the finite volume method on grid with 257 and 129 cells in x and y directions, respectively.

The productivity index is defined as

$$PI = \frac{Q}{{p}_{r} - {p}_{w}} .$$

For a given fracture conductivity distribution, PI does not depend on the pressure drawdown pᵣ-p_{w}. The constant effective fracture conductivity C_{f eff} is selected to have the same productivity index as that for nonuniform conductivity. For the case considered in this example, C_{f eff}≈0.93 C_{f2}.

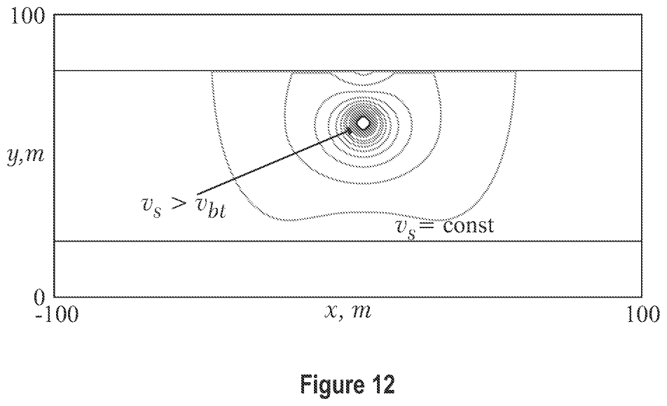

In addition, the superficial velocity was calculated and compared to v_{bt} In this example v_{bt}=0.2 m/s. FIG. 12 shows the contours with constant velocity magnitude and the area with high risk of proppant flowback.

The preceding description has been presented with reference to present embodiments. Persons skilled in the art and technology to which this disclosure pertains will appreciate that alterations and changes in the described structures and methods of operation can be practiced without meaningfully departing from the principle, and scope of this present disclosure. Accordingly, the foregoing description should not be read as pertaining only to the precise structures described and shown in the accompanying drawings, but rather should be read as consistent with and as support for the following claims, which are to have their fullest and fairest scope.

1. A method for hydraulic fracturing and wellbore startup, comprising:
a. determining properties of a reservoir, hydraulic fracturing materials and a wellbore to be stimulated;
b. selecting one or more preliminary designs for a hydraulic fracturing treatment and initiation of well production, wherein the selection of the one or more preliminary designs comprises selection of a maximal pressure drop between the reservoir and the wellbore during the wellbore startup and production;
c. entering data from stages (a) and (b) into one or more computer models for calculating well productivity after the hydraulic fracturing treatment;
d. selecting a treatment design and a well startup design;
e. performing a hydraulic fracturing treatment according to the design of stage (d); and
f. initiating well startup and production.

2. The method of claim 1, wherein the one or more computer models comprise hydraulic fracturing, fracture conductivity and well production models.

3. The method of claim 2, wherein the one or more computer models comprise PKN, KGD, Radial, Pseudo 3D, Planar 3D, Full 3D or UFM or combinations thereof.

4. The method of claim 2, wherein the fracture conductivity model accounts for a pressure-drop effect between the reservoir and the wellbore as the fracture conductivity decreases.

5. The method of claim 2, wherein the fracture conductivity model accounts for proppant flowback during well production.

6. The method of claim 2, wherein the well production model accounts for heterogeneous distribution of fracture conductivity evolving with time.

7. The method of claim 2, wherein the well production model calculates a wellbore productivity index.

8. The method of claim 2, wherein the well production model calculates an equivalent fracture conductivity constant for which the well production is the same as that for heterogeneous conductivity distribution.

9. The method of claim 1, wherein the selection of the one or more preliminary designs comprises selection of concentrations and volumes of the hydraulic fracturing materials, and pumping rate.

10. (canceled)

11. The method of claim 1, wherein the selection of the one or more preliminary designs comprises pulsing injection of the hydraulic fracturing materials.

12. The method of claim 1, wherein the treatment design is selected to maximize well productivity.

13. The method of claim 1, wherein a maximal pressure drop between the reservoir and the wellbore is selected to maximize well productivity.

14. The method of claim 1, wherein the hydraulic fracturing materials comprise fluids, proppants and additives.

15. The method of claim 14, wherein the additives comprise fibers, fluid-loss additives, diverting agents, breakers, corrosion inhibitors, friction reducers, scale inhibitors, surfactants, water soluble polymers, oil-soluble polymers, crosslinkers, biocides, pH adjusting agents or buffers, or combinations thereof.
